(19) United States
(12) Patent Application Publication
(10) Pub. No.: US 2018/0336121 A1
(43) Pub. Date: Nov. 22, 2018

(54) COMPUTER IMPLEMENTED METHOD AND SYSTEM FOR SOFTWARE QUALITY ASSURANCE TESTING BY INTELLIGENT ABSTRACTION OF APPLICATION UNDER TEST (AUT)

(71) Applicants: King Mahendra Alladi, Irving, TX (US); Rajasekhar Karawalla, Little ELM, TX (US)

(72) Inventors: King Mahendra Alladi, Irving, TX (US); Rajasekhar Karawalla, Little ELM, TX (US)

(21) Appl. No.: 15/600,813

(22) Filed: May 22, 2017

(51) Int. Cl. G06F 11/36

(52) U.S. Cl. CPC G06F 11/3664; G06F 11/3608

(57) ABSTRACT

Exemplary embodiments of the present disclosure are directed towards a computer implemented method and system for software quality assurance testing by an abstraction of application under test (AUT), comprising: a step of enabling abstraction of an AUT as a plurality of logically separated Contexts by an visual tool, the visual tool decoupling an entire automation lifecycle process away from the AUT and the plurality of logically separated Contexts becoming basis for the automation lifecycle process. The method further comprising a step of creating an abstract blueprint of the AUT through the plurality of logically separated Contexts by a user, the user creating a plurality of Action stubs in the plurality of logically separated Contexts with a basic information and a plurality Context mutation rules. Analyzing the abstract blueprint of the AUT and marking a plurality of Actions for sharing across the plurality of logically separated Contexts, the plurality of Actions obtaining from the plurality of logically separated Contexts just as a navigational convenience.

### TECHNICAL FIELD

The present disclosure generally relates to the field of automated testing of computer related software programs. More particularly, the present disclosure relates to a computer implemented method and system for software quality assurance testing by intelligent abstraction of application under test (AUT).

### BACKGROUND

Generally, software testing techniques are employed to find the risks associated with the implementation of software. The testing techniques include the process of executing a program or application to find out the software bugs (errors or other defects) and verifying that the software product is suitable for using. Software testing is essential to ensure the software application meets the Customer's needs and works according to the specification. Test Automation is an important component of Software Testing today. The existing test automation solutions require the Software Application to be fully ready and developed before they can be used for testing the Software Application. Additionally, the product owners and other stakeholders in the software development lifecycle have difficulties in understanding how the quality is defined, prioritized, tracked and certified. Based on the above problems, there is also a difficulty to make informed on go or no go decisions on the delivery of software product.

In the light of aforementioned discussion there exists a need for certain systems with novel methodologies that would overcome or ameliorate the above mentioned disadvantages.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards providing visual designer tools to document the intelligent abstraction of AUT blueprint for in-depth analysis by all stakeholders (Product Owners, Engineering, QA, SME).

An objective of the present disclosure is directed towards providing continuous real-time progress and status tracking of the quality efforts during a product's release cycle by quantifying the readiness, coverage and health of all test assets.

An objective of the present disclosure is directed towards contributing natural language based tools to facilitate creation of end to end automation business flow and data injection without any technical complexity.

An objective of the present disclosure is directed towards providing impact-analysis tools to help stakeholders accurately gauge the impact of application rule changes on current state of the automation test assets.

An objective of the present disclosure is directed towards providing an intuitive collaboration tool to allow stakeholders with varied skillsets and roles in an organization to collaborate and contribute towards overall quality of application under test (AUT).

An objective of the present disclosure is directed towards a single source of truth system to facilitate effective and accurate go/no-go decision on software application releases.

Exemplary embodiments of the present disclosure are directed towards a computer implemented method and system of software quality assurance testing by intelligent abstraction of application under test (AUT).

In one or more embodiments, the method comprising a step of enabling abstraction of an AUT as a plurality of logically separated Contexts by a visual tool, the visual tool decoupling an entire automation lifecycle process away from the AUT and the plurality of logically separated Contexts becoming basis for the automation lifecycle process.

In one or more embodiments, the method comprising a step of creating an abstract blueprint of the AUT through the plurality of logically separated Contexts by a user, the user creating a plurality of Action stubs in the plurality of logically separated Contexts with a basic information and a plurality Context mutation rules.

In one or more embodiments, the method further comprising a step of analyzing the abstract blueprint of the AUT and marking a plurality of Actions for sharing across the plurality of logically separated Contexts, the plurality of Actions obtaining from the plurality of logically separated Contexts just as a navigational convenience.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1A is a block diagram depicting a computing environment in accordance with one or more embodiments for testing software quality assurance by intelligent abstraction of application under test (AUT), in accordance with one or more embodiments.

FIG. 1B is a block diagram depicting an example computing device that may be used to implement the various embodiments for testing the software quality assurance by intelligent abstraction of AUT, in accordance with one or more embodiments.

FIG. 2A is a diagram depicting an example software application with Contexts and Actions for decoupling the automated QA life cycle, in accordance with one or more embodiments.

FIG. 2B is a diagram depicting a visual representation of the Context, in accordance with one or more embodiments.

FIG. 2C is a diagram depicting an example Action originating from a Context and resulting in a new Context, in accordance with one or more embodiments.

FIG. 2D is a diagram depicting an example Action which originates from a Context and results in the exit of the application, in accordance with one or more embodiments.

FIG. 2E is a diagram depicting an example Action where the starting and ending Contexts are same, in accordance with one or more embodiments.

FIG. 3A is diagram depicting an example test readiness and coverage analysis screen, in accordance with one or more embodiments.

FIG. 3B is a diagram depicting an example of new test suite and test cases scenario screen, in accordance with one or more embodiments.

FIG. 3C is a diagram depicting an example of a test case representing screen, in accordance with one or more embodiments.

FIG. 4A is a diagram depicting an example of a screen for test asset filtering and searching, in accordance with one or more embodiments.

FIG. 4B is a diagram depicting an example of a screen for current coverage status analysis, in accordance with one or more embodiments.

FIG. 5 is a flow diagram depicting a method for using the application by the subject matter experts and/or business analysts, in accordance with one or more embodiments.

FIG. 6 is a flow diagram depicting a method for using the application by automation engineer, in accordance with one or more embodiments.

FIG. 7 is a flow diagram depicting a method for using the application by engineering team, in accordance with one or more embodiments.

FIG. 8 is a flow diagram depicting a method for using the application by management/scrum master/product owner, in accordance with one or more embodiments.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

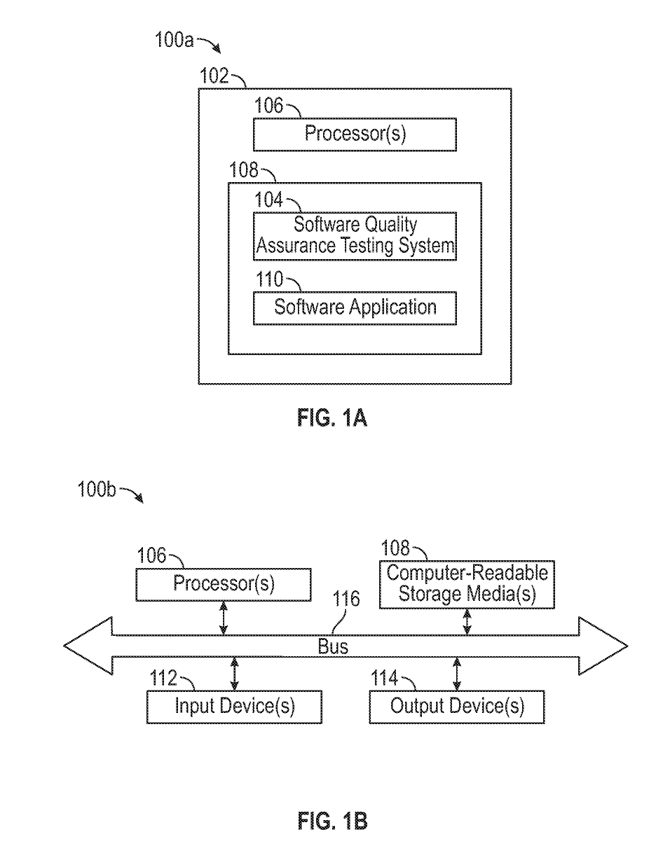

Referring to FIG. 1A is a block diagram 100a depicting a computing environment in accordance with one or more embodiments for testing software quality assurance by intelligent abstraction of application under test (AUT). The environment 100 includes a computing device 102 having a software quality assurance testing system 104 for testing software quality assurance by an abstraction of AUT. The computing device 102 further includes a processor 106, and a computer readable storage media 108. The computer-readable storage media 108 may include, by way of example and not limitation, all forms of volatile and non-volatile memory and/or storage media that are associated with the computing device 102. Such media may include ROM, RAM, flash memory, hard disk, removable media and the like. One specific example of a computing device 102 is shown and described below in FIG. 1B.

According to non-limiting exemplary embodiments of the present disclosure, the computing device 102 further includes a software application (s) 110 that may be stored in the computer readable storage media 108. The software quality assurance testing system 104 may be resided on the computer readable storage media 108 which is executed by the processor 106. The software quality assurance testing system 104 may be accessed as a web application, a mobile application (for example an android application and a IOS application), a software application or other software application known in the art of future implemented, without limiting the scope of the present disclosure. The software quality assurance testing system 104 may be configured to provide unique tools and techniques of abstracting various layers of AUT from the automation of software quality assurance life cycle in the software applications 110. The software applications 110 are being tested for quality assurance by decoupling the Automated QA life cycle from the AUT and generating an abstract blueprint of the software quality assurance testing system 104. The computing device 102 may include, but not limited to, a desktop or a computer, a smart mobile or a tablet, a laptop, or other similar handheld device operated in a network

Referring to FIG. 1B is a block diagram 100b depicting an example computing device that may be used to implement the various embodiments for testing the software quality assurance by intelligent abstraction of AUT. The computing device 102 includes the processor 106, the computer readable storage media 108, an input device 112, an output device (s) 114, and a bus 116 that allows the various components and devices to communicate with one another. The bus 116 represents several types of bus structures, including a memory bus or memory controller, a peripheral bus, an accelerated graphic port and a local bus or processor using any of variety of bus architectures. The bus 116 may include wired and/or wireless buses.

The input and output devices 112-114 allow a user to enter commands and information to the computing device 102, and also allow information to be presented to the user and/or other components or devices. Examples of input devices 112 include a keyboard, a cursor control device (e.g., a mouse), a microphone, a scanner, and the like. Examples of output devices 114 include a display device (e.g., a monitor or projector), speakers, a printer, a network card, and the like.

Various techniques may be described herein in the general Context of software or program modules. Generally, software includes routines, programs, objects, components, data structures, and so forth that perform particular tasks or implement particular abstract data types. An implementation of these modules and techniques may be stored on or transmitted across some form of computer readable media.

According to non-limiting exemplary embodiments of the present disclosure, the software application 110 may be divided into Contexts by the abstraction of AUT. Multiple Actions may be executed in the Contexts by giving input parameters to the contexts. The Actions may return output parameters that capture essential information from the performance of the Action. The software quality assurance by the abstraction of AUT may be configured to monitor the software application's 110 status, progress, and specifically quality assurance of automation projects. The software quality assurance testing system 104 may be configured to monitor the current health and coverage of the software application 110 under test with respect to custom defined metadata fields and rules.

According to non-limiting exemplary embodiments of the present disclosure, the executed Actions may be available from the multiple Contexts due to a navigational convenience by the software quality assurance testing system 104. The software quality assurance testing system 104 may allow marking the Action for sharing across multiple Contexts. For example, when the Action is shared across multiple Contexts, the software quality assurance testing system 104 may show up all the shared Contexts nodes. The software quality assurance testing system 104 may also be configured for analyzing the relationship between various Contexts of the software application 110 covered by the quality assurance of automation projects. The software quality assurance testing system 104 may also perform corrective Actions and apply change reconciliation to improve the current readiness status of the quality assurance automation projects or update the automation assets to improve the assets supporting the software quality assurance automation project.

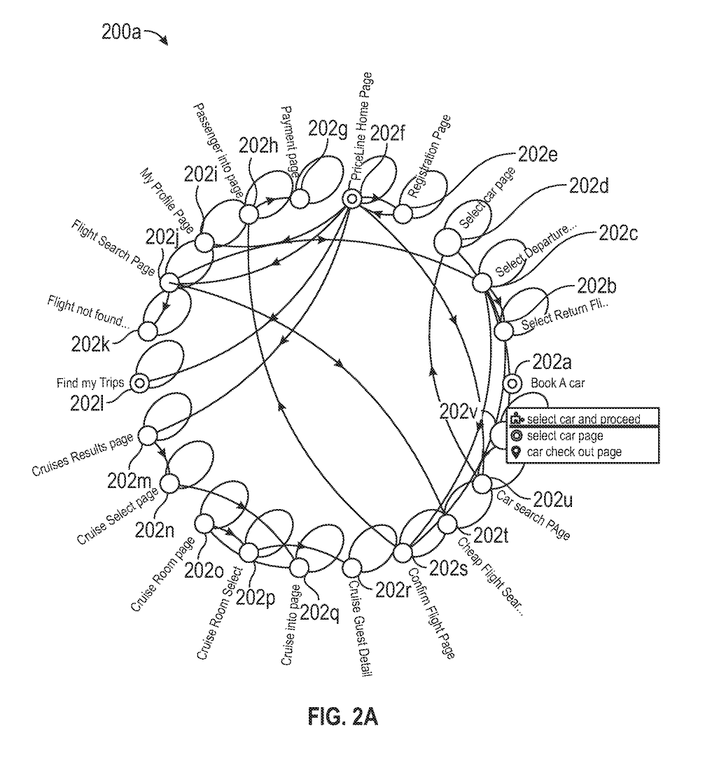

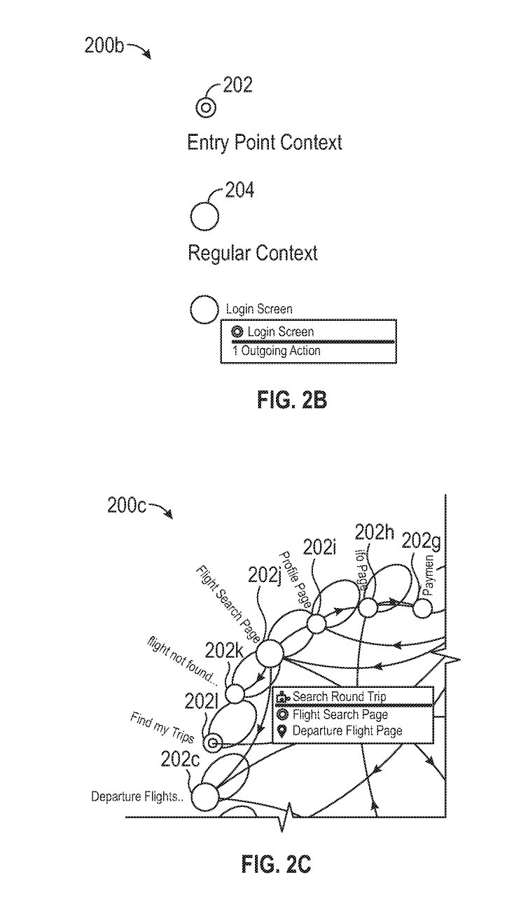

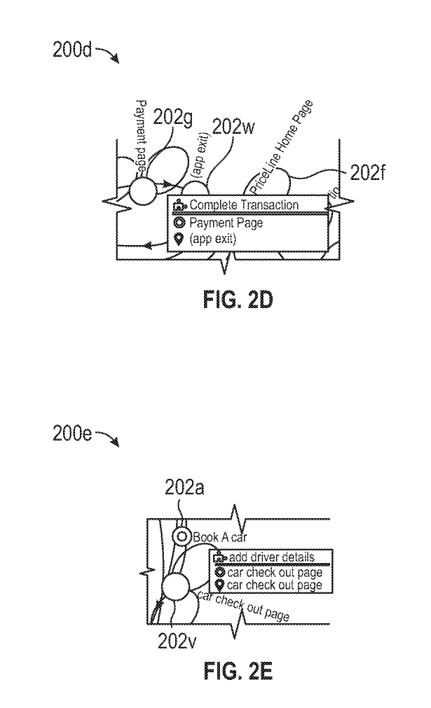

Referring to FIG. 2A is a diagram 200a depicting an example software application with Contexts and Actions for decoupling the automated QA life cycle in accordance with one or more embodiments. The software application 110 includes various Contexts 202a-202v which are logically separated into a set of Contexts 202a-202v from a single source. The logically separated Contexts 202a-202v may be defined as a state of the software application 110. The logically separated Contexts 202a-202v may be a user interface screen, part of screen, state of service, endpoint or any other domain specific entity, and the like without limiting the scope of the disclosure. These logically separated Contexts 202a-202v may be defined as entry point Context which means, a workflow is possible to initiate from this Context without requiring any software logic prior to navigating to the Context.

According to non-limiting exemplary embodiments of the present disclosure, the logically separated Contexts 202a-202v in the software application 110 may be a single source of truth dashboard which is configured for creating and analyzing the application blueprint. The truth dashboard dependencies between various contexts, navigation flow between Actions, Context mutation rules, Scenario flows, current quality assurance progress snapshot and current test readiness state and the like without limiting the scope of the disclosure.

According to non-limiting exemplary embodiments of the present disclosure, the Contexts 202a-202v in the software application 110 may include, but not limited to, book a car page Context, select return page Context, select departure page Context, select car age Context, registration page Context, price line home page Context, payment page Context, passenger info page Context, my profile page Context, flight search page Context, flight not found page Context, find my trips page Context, cruises results page Context, cruises select page Context, cruises room type page Context, cruises room select page Context, cruise info page Context, cruise guest details page Context, confirm flight page Context, cheap flight search page Context, car search page Context, and the like.

Referring to FIG. 2B is a diagram 200b depicting a visual representation of the Context, in accordance with one or more embodiments. The diagram includes a Context 202 which is indicated with a circle, this type of representation referred as “Entry Point Context”. The entry point context referred as a workflow which is possible to initiate from this Context 202 without requiring any software logic prior to navigating to the Context. Each regular Context 204 possesses one or more views for visual representation of the Context. This view represents various fields and controls available in the Context. Here the various fields may be a user ID field, a Password field, a Login button etc. for a Login screen Context and the like without limiting the scope of the disclosure.

Referring to FIG. 2C is a diagram 200c depicting an example search round trip Action originating from the contexts, in accordance with one or more embodiments. The round trip Action 200c may be shared across multiple contexts. The Contexts may include, but not limited to, the find my trips context 2021, the flight not found Context 202k, the flight search page Context 202j, the profile page Context 202i, the information page Context 202h, the payment page Context 202g, departure flights Context 202c, and the like. The search round trip Action may be originated from the flight search page Context 202j and landing in the departure flights page Context 2021. Here the search round trip Action 200c is originating from the “flight search page” Context 202j and the landing in “departure flights page” Context 202c.

Referring to FIG. 2D is a diagram 200d depicting an example complete transaction Action in accordance with one or more embodiments. The contexts may include, but not limited to, the price line home page Context 202f, the payment page Context 202g, the application exit Context 202w, and the like. The figure represents the “complete transaction” Action originating from payment page Context and application exit Context.

Referring to FIG. 2E is a diagram 200e depicting an example Action for adding driver details, in accordance with one or more embodiments. An Action (for example driver details) may be added to the Context. The Contexts 202a, 202v here may include, but not limited to, the book a car page Context 202a, the car check out page Context 202v, and the like. The example Action may be represented the destination context as the current Context.

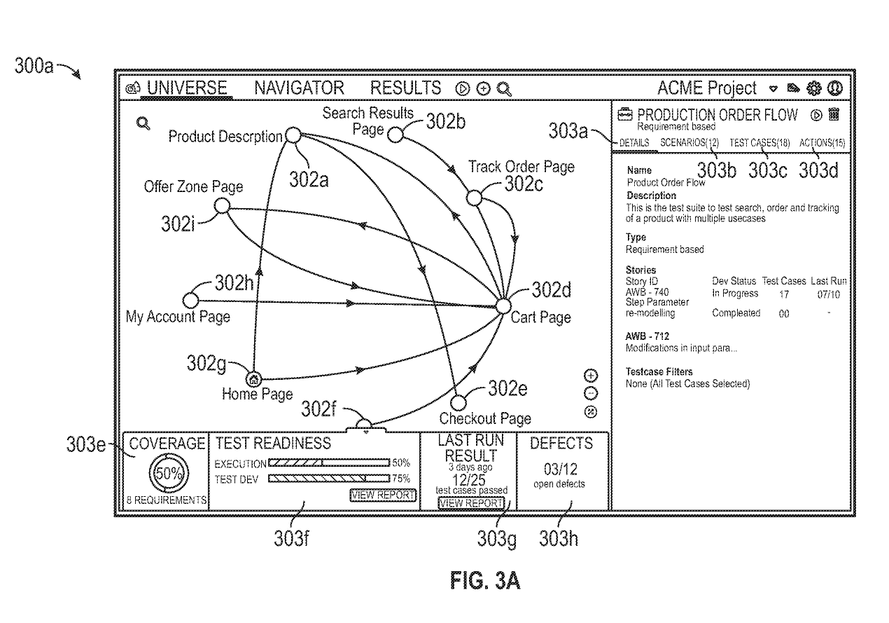

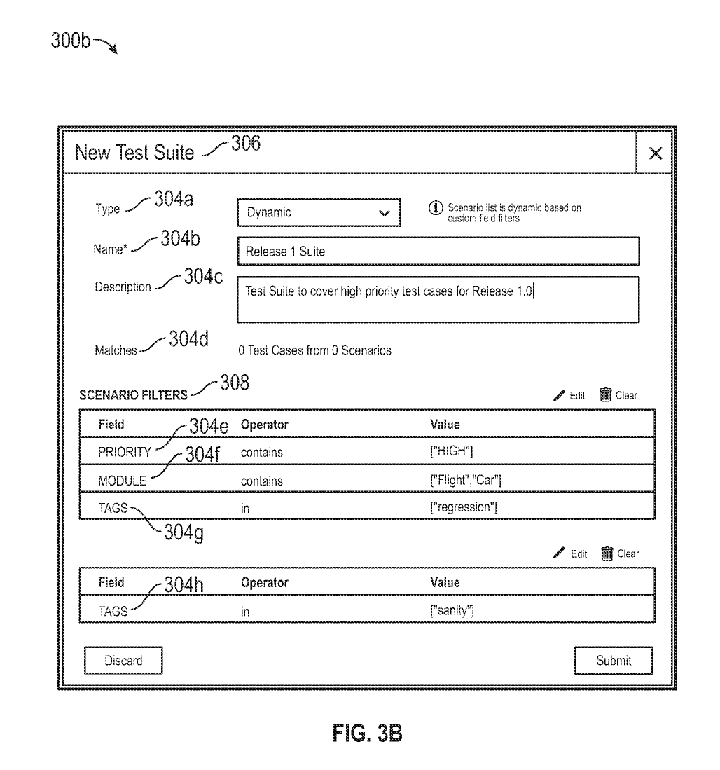

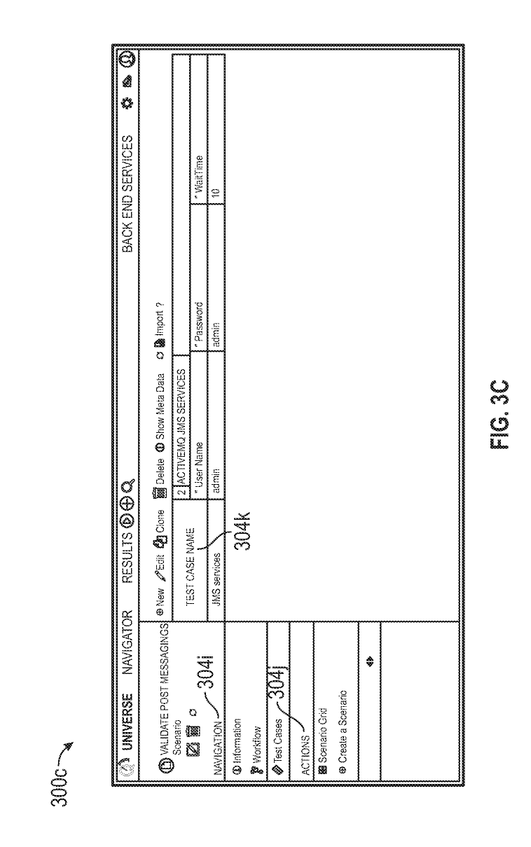

Referring to FIG. 3A is diagram 300a depicting an example test readiness and coverage analysis screen, in accordance with one or more embodiments. The test readiness and coverage analysis screen 300a depicts workflow emulated as a series of Actions executed in sequential order in various Contexts 302a-302i. The Contexts 302a-302i may be enabled to give an order for a product. The Contexts 302a-302i may include, but not limited to, a home page, a checkout page, a cart page a track order page, a search results page, a product description page, an offer zone page, a my account page and the like.

The test readiness and coverage analysis screen 300a depicts details 303a, number of Scenarios 303b, number of test cases 303c and number of Actions 303d. The test readiness and coverage analysis screen 300a further depicts name, description, type, stories, and test case filters. The test readiness and coverage analysis screen 300a further depicts a coverage area percentage 303e, a test readiness 303f, last run result 303g and defects 303h.

Referring to FIG. 3B is a diagram 300b depicting an example of new test suite and test cases Scenario screen, in accordance with one or more embodiments. The new test suite 306b includes type 304a, name 304b, description 304c and matches 304d. Here the test suite type 304a may be a static, dynamic or requirements based suite. The new test suite 300d contains Scenario filters 308 which include priority 304e, module 304f and tags 304g. Further the new test suite 300d contains test case filters 308 which include tags 304h.

According to non-limiting exemplary embodiments of the present disclosure, the test suite may be a collection of Scenarios and test cases assembled for a specific objective. The test suites may be setup as a static, dynamic or requirements based suite. The dynamic suite may allow specifying a filter criterion for the member Scenarios and test cases without explicitly selecting by the name The requirements based test suite may allow creating a test suite to cover a set of requirements managed in external enterprise systems such as jira. As a release cycle evolves, more and more Scenarios and test cases are tagged to match the filter criterion or requirements and the complete test suite starts to form.

According to non-limiting exemplary embodiments of the present disclosure, Scenario data refers to the collection of input parameter data of all the included Actions in the Scenario. To ensure coverage various data combinations, same Scenario can be executed with different sets of data. Such data is managed in the data table associated with Scenario.

Referring to FIG. 3C is a diagram 300c depicting an example of a test case representing screen, in accordance with one or more embodiments. The test case representing screen 300c includes navigation 304i and Actions 304j. In the navigation, 304i comprises information, workflow and test cases and the Actions 304j comprises scenario grid and create a scenario. The test case provides parameters of the selected test case 304k.

According to non-limiting exemplary embodiments of the present disclosure, a Scenario can be driven by multiple instances of data grouped as scenario test cases. Each test case specifies a specific data set for a Scenario. In the instances where the Scenario workflow does not need any data from the data table (there are either no parameters for Scenario steps or all the parameters have been supplied with fixed values), the Scenario itself represents one test case.

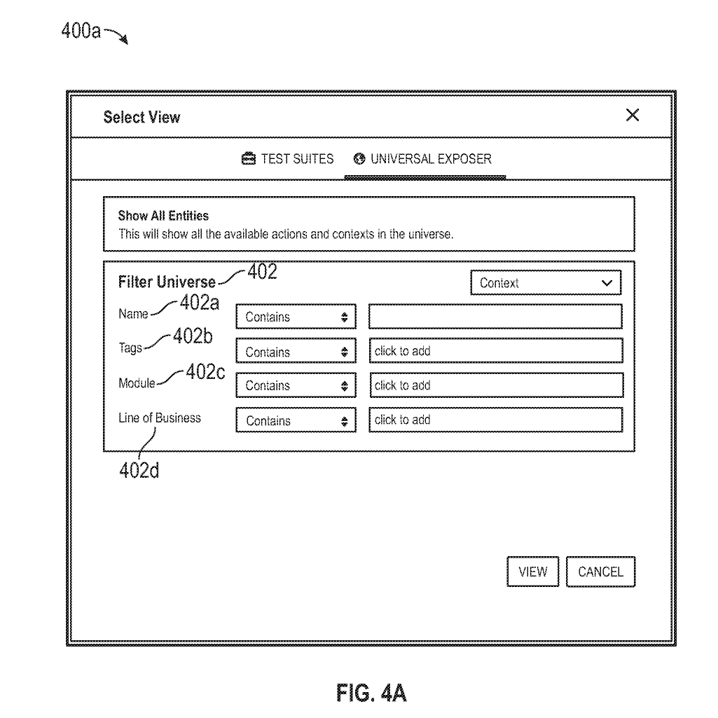

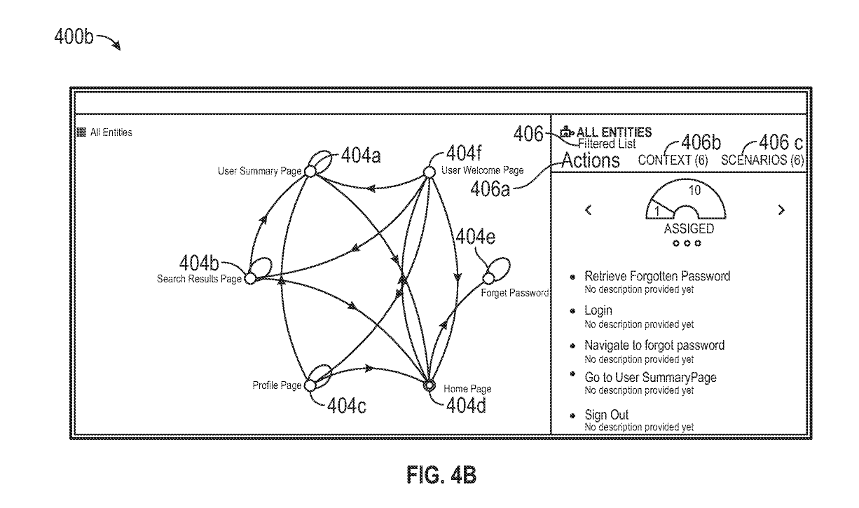

Referring to FIG. 4A is a diagram 400a depicting an example of a screen for test asset filtering and searching, in accordance with one or more embodiments. The screen 400a depicts a filter universe 402 which comprises, name 402a, tags 402b, module 402c, line of business 402d, and the like.

According to non-limiting exemplary embodiments of the present disclosure, the user may setup advanced filters based on various custom fields and tags associated with Actions, Contexts and Scenarios depending on the specific area of interest. Once the filter is set up, the subset may be reflected. The screen 400a may be enabled to depict the available Actions and the Contexts.

Referring to FIG. 4B is a diagram 400b depicting an example of a screen for current coverage status analysis, in accordance with one or more embodiments. The current coverage status analysis screen 400b depicts 404a-404f which may include, but not limited to, home page Context, forget password Context, user welcome page Context, user summary page Context, search results page Context, profile page Context, and the like. The current coverage status analysis screen 400b further depicts filtered list 406. The filtered list 406 further includes number of Actions 406a, number of Contexts 406b, number of Scenarios 406c, and the like.

According to non-limiting exemplary embodiments of the present disclosure, the users may determine the coverage status of the Actions defined in the system by through a status of the Action (assigned/not assigned)

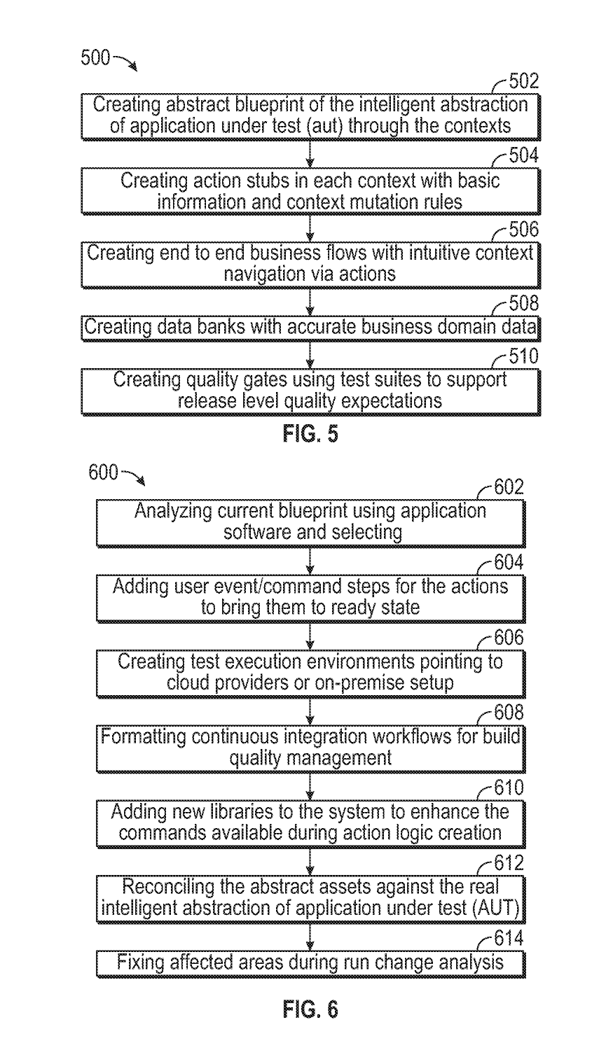

Referring to FIG. 5 is a flow diagram 500 depicting a method for using the application by the subject matter experts and/or business analysts, in accordance with one or more embodiments. The method 500 may also be carried out in any desired environment. Further, the aforementioned definitions may equally apply to the description below.

The method commences at step 502, wherein the user may create the abstract blueprint of the AUT through the Contexts which represents the logical division of the system aligning to the requirements. The user may create Action stubs in each Context with basic information and Context mutation rules at step 504. The user may create end to end business flows with intuitive Context navigation via Actions at step 506. Further the user may create data banks with accurate business domain data, and also create quality gates using test suites to support release level quality expectations, at steps 508 and 510.

Referring to FIG. 6 is a flow diagram 600 depicting a method for using the application by automation engineer, in accordance with one or more embodiments. The method 600 may also be carried out in any desired environment. Further, the aforementioned definitions may equally apply to the description below.

The method commences at step 602, the automation engineer may analyze current blueprint using application universe and select the Actions that are not in ready state. At step 604, add the user event/command steps for Actions which bring them to ready state. Creating the test execution environments pointing to cloud providers or on premise setup is performed at step 606. Setting up continuous integration workflows for build quality management is performed at step 608, then add new Libraries to the system to enhance the commands available during Action logic creation with domain specific commands is performed at step 610. Further reconciliation of the abstract assets against the Real AUT and Run change analysis heuristics and fix affected areas is performed at step 612 and 614.

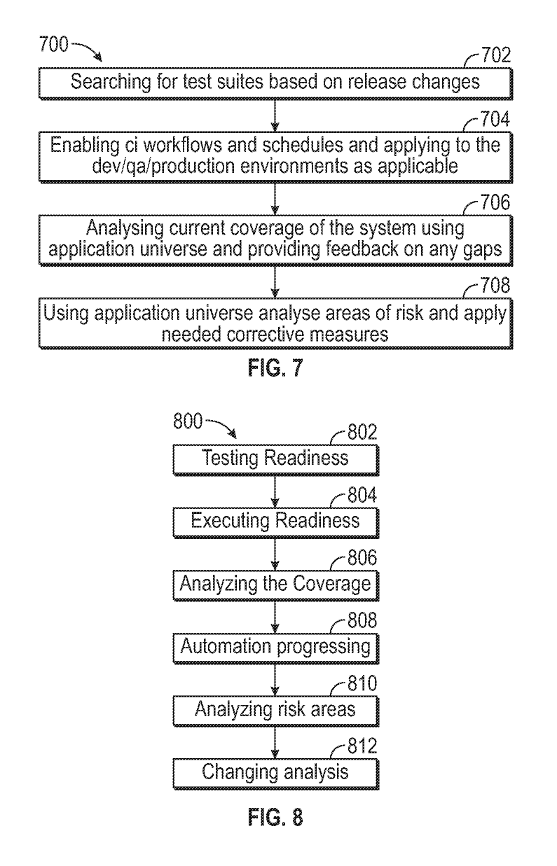

Referring to FIG. 7 is a flow diagram 700 depicting a method for using the application by engineering team, in accordance with one or more embodiments. The method 700 may also be carried out in any desired environment. Further, the aforementioned definitions may equally apply to the description below.

The method commences at step 702, wherein the engineering team may search for test suites based on release changes. At step 704, the engineering team may enable to CI workflows, schedules and apply to the DEV/QA/production environments which are applicable. At step 706, analyzing current coverage of the system using application universe and feedback is provided on any gaps. Analyzing areas of risk and applying needed corrective measures of the Context is performed at step 708.

Referring to FIG. 8 is a flow diagram 800 depicting a method for using the application by management/scrum master/product owner, in accordance with one or more embodiments. The method 800 may also be carried out in any desired environment. Further, the aforementioned definitions may equally apply to the description below.

The method commences at step 802, the product owner may be enabled to view the test readiness. At step 804, the product owner may analyze the execution readiness and coverage of the Action at step 806. The product owner may be enabled to check the automation progress at step 808 and analyse areas of risk and may apply needed corrective changes of the Context at step 810 and 812.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions. It should also be noted that, in some alternative implementations, the functions noted in the block may occur in any order or out of the order noted in the figures.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A method for software quality assurance testing by intelligent abstraction of application under test (AUT), comprising:
enabling abstraction of an AUT as a plurality of logically separated Contexts by an visual tool, wherein the visual tool decoupling an entire automation lifecycle process away from the AUT and the plurality of logically separated Contexts becoming basis for the automation lifecycle process;
creating an abstract blueprint of the AUT through the plurality of logically separated Contexts by an user, whereby the user creating a plurality of Action stubs in the plurality of logically separated Contexts with a basic information and a plurality Context mutation rules; and
analyzing the abstract blueprint of the AUT and marking a plurality of Actions for sharing across the plurality of logically separated Contexts, wherein the plurality of actions obtaining from the plurality of logically separated Contexts just as a navigational convenience.

2. The method of claim 1, further comprising a step of creating a scenario by stitching the plurality of logically separated Contexts through the plurality of Actions with the plurality of Context mutation rules.

3. The method of claim 1, further comprising a step of navigating the abstract blueprint to achieve the business flow automation by the applied plurality of Context mutation rules.

4. The method of claim 1, further comprising a step of analyzing a QA snapshot of the AUT.

5. The method of claim 1, further comprising a step of determining the coverage status of the plurality of Actions.

6. A method for software quality assurance testing by intelligent abstraction of application under (AUT), comprising:
creating an abstract blueprint of AUT through a plurality of logically separated Contexts by an user, whereby the user creating a plurality of action stubs in the plurality of logically separated Contexts with basic information and Context mutation rules; and
erecting a plurality of end to end business flows with intuitive context navigation through a plurality of Actions, wherein creating a plurality of data banks with accurate business domain data and creating a plurality of quality gates using test suites to support release level quality expectations.

7. The method of claim 6, further comprising a step of analyzing the abstract blueprint and selecting the plurality of Actions that are not in ready state.

8. The method of claim 6, further comprising a step of adding a plurality command steps for the plurality of Actions bring them to the ready state.

9. The method of claim 6, further comprising a step of creating a plurality of test execution environments pointing to a plurality of cloud providers.

10. The method of claim 6, further comprising a step of setting up continuous integration workflows for building quality management.

11. The method of claim 6, further comprising a step of adding a plurality of libraries to enhance the plurality of command steps available during Action logic creation with domain specific commands

12. The method of claim 6, further comprising a steps of viewing a test readiness, analyzing the execution readiness, checking automation progress and analyzing risk areas.

13. A system for software quality assurance testing by an abstraction of application under test (AUT), comprising:
one or more processors;
one or more computer-readable storage media storing instructions when executed, perform operations comprising:
a software application is divided into a plurality of logically separated Contexts, wherein the plurality of logically separated Contexts allowed to execute a plurality Actions by giving a plurality of input parameters to the software application;
an essential information is captured from a plurality of output parameters by the plurality of Actions, wherein the plurality of Actions obtained in the plurality of Contexts by a navigational convenience;
a plurality of advanced filters are enabled based on the plurality of logically separated Contexts and the plurality of Actions configured for filtering;
a current readiness status of the plurality of Actions is analyzed and a plurality of different indicator modes switched;
a path is reflected by a Scenario in the software application by the plurality of Actions executed in a sequential order in the plurality of logically separated Contexts; and
at least one software quality assurance testing system is configured to execute the stored instructions in the one or more computer readable storage media.

14. The system of claim 13, wherein the software quality assurance testing system is configured to monitor the plurality of filtered set of Contexts and the plurality of filtered set of Actions.

15. The system of claim 13, wherein the software quality assurance testing system is configured to calculate the test readiness as a function of a plurality dependency parameters to indicate the test effort.

16. The system of claim 13, wherein the software quality assurance testing system is configured to select the Scenario or test suite and analyze the selected Scenario for monitoring current state of a test or Scenario readiness, coverage percentage of requirements and development status of the requirements.

17. The system of claim 13, wherein the software quality assurance testing system is configured to execute the stored instructions in the one or more computer readable storage media.

18. The system of claim 13, wherein the software quality assurance testing system is configured to select a particular test execution result and a plurality of failures are highlighted in a predefined color in the plurality of actions and the plurality of contexts.

19. The system of claim 13, wherein the Scenario is depicted by the plurality of logically separated Contexts and the plurality of Actions starting from the plurality of entry point Contexts and leading into the plurality of final destination Contexts.

20. A computer program product comprising module code embedded in a non-transitory data storage medium, wherein execution of the module code on a computing device causes the computing device to:
divide a software application into a plurality of logically separated Contexts, wherein the plurality of logically separated Contexts allowed to execute a plurality Actions by giving a plurality of input parameters to the software application;
capture an essential information from a plurality of output parameters by the plurality of Actions, wherein the plurality of Actions are obtained in the plurality of logically separated Contexts by a navigational convenience;
enable a plurality of advanced filters based on the plurality of logically separated Contexts and the plurality of Actions for filtering;
analyze a current readiness status of the plurality of Actions and switching to a plurality of different indicator modes;
reflect a path by a Scenario in the software application by the plurality of Actions executed in a sequential order in the plurality of logically separated Contexts; and
monitor a current state of a test or Scenario readiness, coverage percentage of requirements and development status of the requirements by selecting at least one test suite or the Scenario.
